(19) United States
(12) Patent Application Publication
(10) Pub. No.: US 2018/0052281 A1
(43) Pub. Date: Feb. 22, 2018

(54) SUBSTRATE, SEMICONDUCTOR DEVICE AND SEMICONDUCTOR PACKAGE STRUCTURE

(71) Applicant: Advanced Semiconductor Engineering, Inc., Kaohsiung (TW)

(72) Inventors: Hung-Chun KUO, Kaohsiung (TW); Wei Lun WANG, Kaohsiung (TW)

(73) Assignee: Advanced Semiconductor Engineering, Inc.

(21) Appl. No.: 15/238,331

(22) Filed: Aug. 16, 2016

(51) Int. Cl. G02B 6/12; H04B 1/38; G02B 6/122; G02B 6/42

(52) U.S. Cl. CPC G02B 6/12002; H04B 1/38; G02B 6/12004; G02B 6/428; G02B 6/4239; G02B 6/1221

(57) ABSTRACT

A substrate for a semiconductor device includes a polymer material filling at least one through hole extending through the substrate. and at least one optical waveguide disposed within the through hole and extending through the polymer material. A refractive index of the optical waveguide is greater than a refractive index of the polymer material.

### BACKGROUND

### 1. Field of the Disclosure

The present disclosure relates to the fields of substrates, semiconductor devices, and semiconductor package structures, and more particularly, to a substrate including an optical waveguide and a semiconductor package structure including an optical device.

### 2. Description of the Related Art

In a package-on-package (POP) structure, the top substrate is electrically connected to the bottom substrate through interconnections (e.g., solder balls) disposed therebetween. Signals (including input/output (I/O) signals, power signals (PWR) and ground signals (GND)) transmitted between the top substrate and the bottom substrate are transmitted through the interconnections. Due to limited interconnection count, it can be difficult to assign interconnections to achieve a POP structure with high speed signal transmission.

### SUMMARY

In one or more embodiments, a substrate for a semiconductor device includes a polymer material filling at least one through hole extending through the substrate, and at least one optical waveguide disposed within the through hole and extending through the polymer material. A refractive index of the optical waveguide is greater than a refractive index of the polymer material.

In one or more embodiments, a semiconductor device includes a first substrate and a second substrate. The first substrate includes a polymer material filling a through hole in the first substrate, and an optical waveguide disposed within the through hole and extending through the polymer material. The semiconductor device further includes a first semiconductor die disposed on and electrically connected to the first substrate, and a first optical device electrically connected to the first substrate, the first optical device disposed above the optical waveguide. The second substrate is electrically connected to the first substrate. A second semiconductor die is disposed on and electrically connected to the second substrate. A second optical device is electrically connected to the second substrate, and the second optical device is disposed under the optical waveguide.

In one or more embodiments, a semiconductor package structure includes a semiconductor die, an optical device electrically connected to the semiconductor die, and an encapsulant. The optical device includes an optical surface for emitting and receiving light. The encapsulant encapsulates the semiconductor die and the optical device, and exposes a portion of the optical surface.

### BRIEF DESCRIPTION OF THE DRAWINGS

FIG. 1 illustrates a cross-sectional view of a semiconductor device according to an embodiment of the present disclosure.

FIG. 2 illustrates an enlarged view of an area of the semiconductor device of FIG. 1.

FIG. 3 illustrates a top view of an example of a semiconductor device according to an embodiment of the present disclosure.

FIG. 4 illustrates a top view of an example of an optical device according to an embodiment of the present disclosure.

FIG. 5 illustrates a top view of an example of an optical device according to an embodiment of the present disclosure.

FIG. 6 illustrates a block diagram of an optical device according to an embodiment of the present disclosure.

FIG. 7 illustrates a block diagram of a first semiconductor die and a second semiconductor die according to an embodiment of the present disclosure.

FIG. 8 illustrates a top view of a semiconductor device according to an embodiment of the present disclosure.

FIG. 9 illustrates a cross-sectional view of a semiconductor device according to an embodiment of the present disclosure.

FIG. 10, FIG. 11, FIG. 12, FIG. 13, FIG. 14, FIG. 15 and FIG. 16 illustrate a manufacturing process according to an embodiment of the present disclosure.

### DETAILED DESCRIPTION

During operation of an electrical device, an electrical current in a semiconductor die passes through signal circuits (e.g., I/O, PWR, GND circuits) in a package structure that includes the semiconductor die, as well as through a printed circuit board to which the package structure may be attached. Logic level changes in a signal transmitted through an I/O circuit can result in a voltage fluctuation in the PWR/GND circuits due to changes in electrical current related to changes in logic levels in the I/O circuits. Voltage fluctuation in the PWR/GND circuits can in turn result in offsets and spikes in the I/O circuits, which, as signal transmission speed increases, can result in a loss of signal integrity and a decrease in transmission power. For example, higher speed transmission in a transmission path results in decreased transmission time, dt, which has a proportionally inverse relationship to voltage fluctuation (ΔV) as shown in equation (1), where L is an inductance of the transmission path including the PWR/GND circuits and dl refers to a change in current in the transmission path (e.g., as a signal in the signal path changes logic levels during a signal transmission).

$$Δ V = L \frac{dI}{dt} \qquad ( 1 )$$

Inductance (L) of the transmission path can be reduced to reduce voltage fluctuation (ΔV), as can be seen by equation (1). One way to reduce the inductance (L) is to increase a count of interconnections for PWR/GND signals. However, a total count of interconnections may be limited and thus a count of interconnections available for PWR/GND signals may also be limited. For example, if there are a total of 100 interconnections in which 80 interconnections are reserved for I/O signals, then 20 are available for PWR/GND signals, which is not a sufficient number to adequately reduce inductance (L) for high speed transmission.

To address the above concerns, two optical engines can be added in a POP structure, where the top substrate is a glass substrate and the two optical engines are optically coupled with each other through the glass substrate for transmitting selected I/O signals. However, warpage of the glass substrate can occur because of a mismatch of coefficient thermal expansion (CTE) between a top side and a bottom side of the glass substrate, which warpage can affect yield in subsequent stages of manufacturing.

To address CTE mismatch, the present disclosure provides an improved substrate with an optical waveguide for transmitting selected I/O signals optically between a top die and a bottom die, and improved techniques for manufacturing the substrate. For example, according to embodiments of the present disclosure, a top optical engine on a top substrate is optically coupled through an optical waveguide in the top substrate to a bottom optical engine on a bottom substrate. Selected I/O signals form the top die are transmitted to the bottom die by optical transmission between the top optical engine and the bottom optical engine. Other I/O signals from the top die are transmitted to the bottom die by electrical transmission through interconnections. The top substrate may be an organic substrate, which exhibits low warpage.

Because some or all of the I/O signals may be routed through the optical engines and waveguide, most or all of the interconnections of the top die and the bottom die can be assigned to PWR/GND, to reduce inductance (e.g., for higher transmission rates), reduce voltage fluctuation (ΔV), and also to accommodate higher current. Therefore, higher quality of signal transmission may be achieved (e.g., reduced transmission loss).

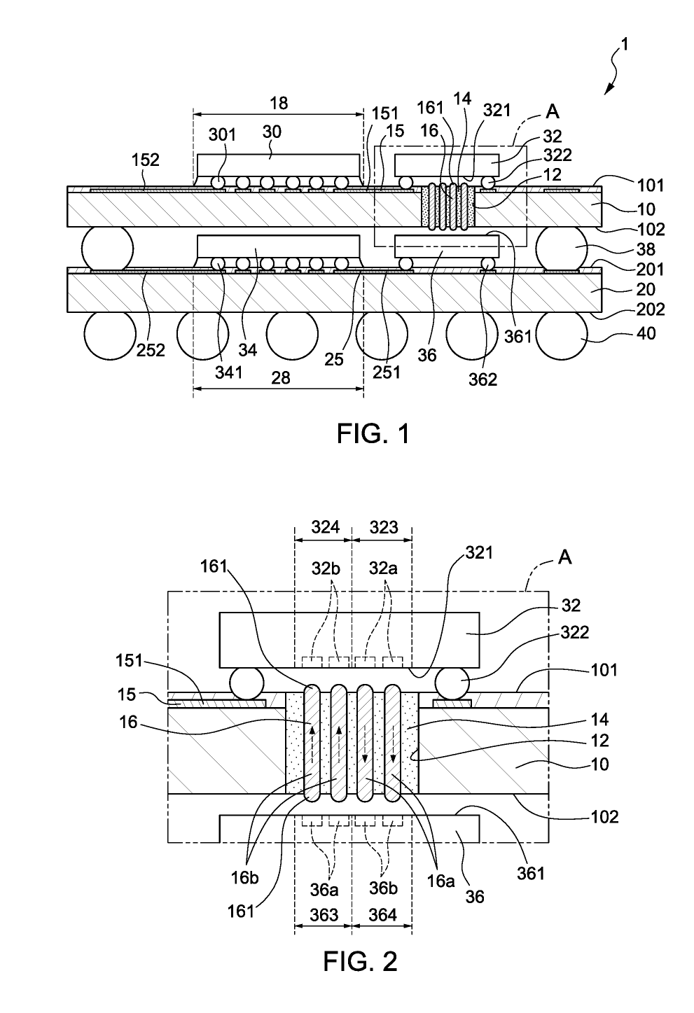

FIG. 1 illustrates a cross-sectional view of a semiconductor device 1 according to an embodiment of the present disclosure. The semiconductor device 1 includes a first substrate 10, a first semiconductor die 30, a first optical device 32, a second substrate 20, a second semiconductor die 34, a second optical device 36 and interconnections 38.

In one or more embodiments, the first substrate 10 may be a glass substrate, a ceramic substrate or an organic substrate. In one or more embodiments, the first substrate 10 is an organic substrate which includes multiple insulation layers and multiple metal circuit layers (not shown). That is, the insulation layers and the metal circuit layers are laminated together so that the metal circuit layers are interspersed between the insulation layers. For example, the first substrate 10 may include two, four, six or more embedded metal circuit layers.

As shown in FIG. 1, the first substrate 10 includes a substrate body having a first surface 101 and a second surface 102 opposite to the first surface 101, and the first substrate 10 defines at least one through hole 12. The first substrate includes a first metal layer 15, a first die bonding area 18 and at least one optical waveguide 16. The through hole 12 extends through the first substrate 10, and is substantially filled with a polymer material 14. In one or more embodiments, the polymer material 14 is a photo sensitive material, which may include polymethyl methacrylate (PMMA), an epoxy-based photoresist (e.g., SU-8), or other suitable material. The first metal layer 15 and the first die bonding area 18 are disposed adjacent to the first surface 101 of the first substrate 10. The first semiconductor die 30 is disposed on or mounted on the first die bonding area 18.

The first metal layer 15 includes a first portion 151 and a second portion 152. The first portion 151 of the first metal layer 15 extends from the first die bonding area 18 to a periphery of the through hole 12 where the first optical device 32 is disposed on or mounted on. The second portion 152 of the first metal layer 15 extends from the first die bonding area 18 towards a periphery of the first substrate 10 to electrically connect to one or more of the interconnections 38. As shown in FIG. 1, the first substrate 10 includes one through hole 12 and multiple optical waveguides 16 that are disposed within the through hole 12. Each of the optical waveguides 16 extends through the polymer material 14. Thus, two ends of each of the optical waveguides 16 are exposed from the polymer material 14.

The first semiconductor die 30 is disposed on and electrically connected to the first substrate 10. As shown in FIG. 1, the first semiconductor die 30 is disposed on or mounted on the first die bonding area 18 through first bumps 301, and the first bumps 301 are electrically connected to the first metal layer 15. The first optical device 32 is electrically connected to the first substrate 10 through bumps 322, and is disposed above the optical waveguides 16. In the embodiment illustrated in FIG. 1, the first optical device 32 is an optical engine that includes a first optical surface 321. The first optical surface 321 faces the optical waveguides 16, and is used for emitting and receiving light. The bumps 322 are disposed at the periphery of the through hole 12 to electrically connect to the first portion 151 of the first metal layer 15. Thus, the first semiconductor die 30 is electrically connected to the first optical device 32 through the first portion 151 of the first metal layer 15.

The second substrate 20 is electrically connected to the first substrate 10. As shown in FIG. 1, the second substrate 20 is disposed under the first substrate 10, and is electrically connected to the first substrate 10 through the interconnections 38. In one or more embodiments, the second substrate 20 may be a glass substrate, a ceramic substrate or an organic substrate. In one or more embodiments, the second substrate 20 is an organic substrate which includes multiple insulation layers and multiple metal circuit layers. That is, the insulation layers and the metal circuit layers are laminated together so that the metal circuit layers are interspersed between the insulation layers. For example, the second substrate 20 may include two, four, six or more embedded metal circuit layers.

As shown in FIG. 1, the second substrate 20 has a first surface 201 and a second surface 202 opposite to the first surface 201. The second substrate 20 includes a second metal layer 25 and a second die bonding area 28 disposed adjacent to the first surface 201 of the second substrate 20. The second semiconductor die 34 is disposed on or mounted on the second die bonding area 28. The second metal layer 25 includes a first portion 251 and a second portion 252. The first portion 251 of the second metal layer 25 extends from the second die bonding area 28 to a predetermined area where the second optical device 36 is disposed or mounted. The second portion 252 of the second metal layer 25 extends from the second die bonding area 28 towards a periphery of the second substrate 20 to electrically connect to the interconnections 38.

The second semiconductor die 34 is disposed on and electrically connected to the second substrate 20. As shown in FIG. 1, the second semiconductor die 34 is disposed on or mounted on the second die bonding area 28 through second bumps 341, and the second bumps 341 are electrically connected to the second metal layer 25. The second optical device 36 is electrically connected to the second substrate 20 through bumps 362, and is disposed under the optical waveguides 16. The second optical device 36 is aligned with the first optical device 32. The second optical device 36 is an optical engine that includes a second optical surface 361. The second optical surface 361 faces the optical waveguides 16, and is used for emitting and receiving light, so that the first optical device 32 is optically coupled to the second optical device 36 through the optical waveguides 16. The bumps 362 are disposed at the predetermined area to electrically connect to the first portion 251 of the second metal layer 25. Thus, the second semiconductor die 34 is electrically connected to the second optical device 36 through the first portion 251 of the second metal layer 25.

The interconnections 38 (e.g., solder balls) are disposed between the first substrate 10 and the second substrate 20, and electrically connect the first substrate 10 and the second substrate 20. In one or more embodiments, the semiconductor device 1 may further include external connection elements 40 (e.g., solder balls) disposed adjacent to the second surface 202 of the second substrate 20 for external connection.

In the embodiment illustrated in FIG. 1, the first optical device 32 is optically coupled with the second optical device 36 through the optical waveguides 16 in the first substrate 10 for transmitting selected I/O signals. Therefore, the selected I/O signals are transmitted between the first semiconductor die 30 and the second semiconductor die 34 by optical transmission between the first optical device 32 and the second optical device 36, and other I/O signals between the first semiconductor die 30 and the second semiconductor die 34 may be transmitted by electrical transmission through the interconnections 38. In addition, the first substrate 10 may be an organic substrate, which may exhibit low warpage.

Thus, most of the bumps 301 of the first semiconductor die 30, most of the bumps 341 of the second semiconductor die 34, and most of the interconnections 38 can be assigned to PWR/GND pins to reduce inductance and increase current capability. Accordingly, voltage fluctuation (ΔV) is reduced, and signal transmission quality can be increased (e.g., reduced transmission loss).

FIG. 2 illustrates an enlarged view of an area A of the semiconductor device 1 of FIG. 1. In the embodiment illustrated in FIG. 2, the through hole 12 is substantially filled with the polymer material 14. A top surface of the polymer material 14 is substantially coplanar with the first surface 101 of the first substrate 10, and a bottom surface of the polymer material 14 is substantially coplanar with the second surface 102 of the first substrate 10. Further, the optical waveguides 16 are embedded in the polymer material 14; thus, each of the optical waveguides 16 is surrounded by the polymer material 14, and two ends of the optical waveguides 16 are exposed from the polymer material 14. A refractive index of the optical waveguides 16 is greater than a refractive index of the polymer material 14, so that light (optical signals) can be effectively transmitted between the first optical device 32 and the second optical device 36 through the optical waveguides 16. In one or more embodiments, the optical waveguides 16 are formed from the polymer material 14. For example, a portion of the polymer material 14 is irradiated by a laser (e.g., a proton laser, an ultraviolet (UV) laser or an infrared (IR) laser) so as to form the optical waveguides 16.

In addition, the semiconductor device 1 further includes micro-lenses 161 disposed at the ends (both top and bottom) of the optical waveguides 16. In one or more embodiments, the micro-lenses 161 are formed from the optical waveguides 16. For example, an end of an optical waveguide 16 is irradiated by a laser (e.g., a proton laser, UV laser or an IR laser) to melt the waveguide 16 and form a micro-lens 161 due to surface tension. Therefore, a material and a refractive index of the micro-lens 161 are the same as a material and a refractive index of the optical waveguide 16. The micro-lens 161 can focus light (optical signals) transmitted between the first optical device 32 and the second optical device 36.

As shown in FIG. 2, the first optical device 32 further includes a light emitting region 323, a light receiving region 324, light emitting units 32a and light receiving units 32b. The light emitting region 323, the light receiving region 324, the light emitting units 32a and the light receiving units 32b are disposed adjacent to the first optical surface 321. The light emitting units 32a are disposed within the light emitting region 323, and are used for emitting light (optical signals). The light receiving units 32b are disposed within the light receiving region 324, and are used for receiving light (optical signals). The second optical device 36 further includes a light emitting region 363, a light receiving region 364, light emitting units 36a and light receiving units 36b. The light emitting region 363, the light receiving region 364, the light emitting units 36a and the light receiving units 36b are disposed adjacent to the second optical surface 361. The light emitting units 36a are disposed within the light emitting region 363, and are used for emitting light (optical signals). The light receiving units 36b are disposed within the light receiving region 364, and are used for receiving light (optical signals).

Each of the light emitting units 32a of the first optical device 32 corresponds to a respective light receiving unit 36b of the second optical device 36, and an optical waveguide 16 therebetween is a first optical waveguide 16a. The light (optical signals) is transmitted from the light emitting units 32a of the first optical device 32 to the light receiving units 36b of the second optical device 36 through the first optical waveguides 16a. Each of the light receiving units 32b of the first optical device 32 corresponds to a respective light emitting unit 36a of the second optical device 36, and the optical waveguide 16 therebetween is a second optical waveguide 16b. The light (optical signals) is transmitted from the light emitting units 36a of the second optical device 36 to the light receiving units 32b of the first optical device 32 through the second optical waveguides 16b.

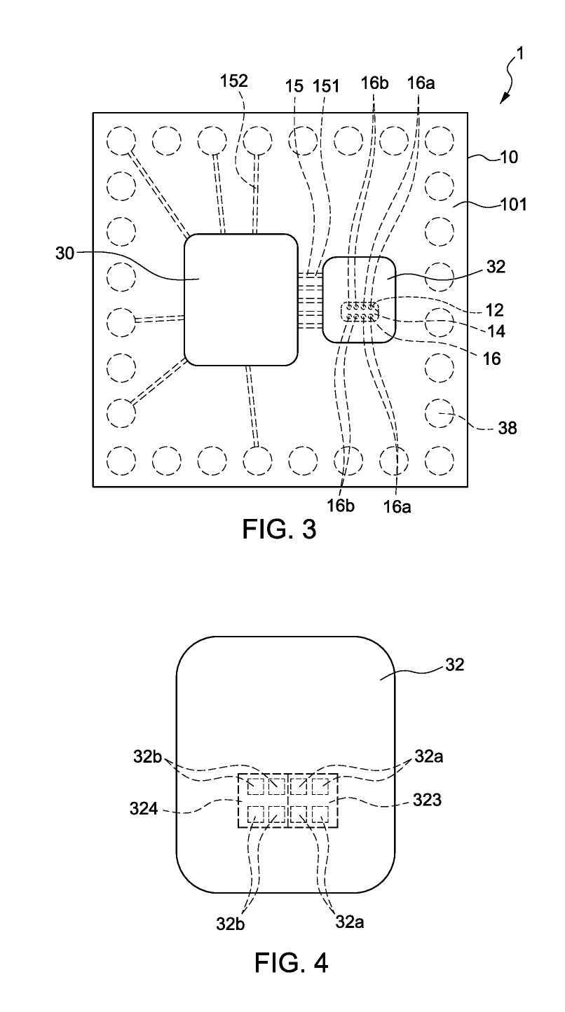

FIG. 3 illustrates a top view of an example of the semiconductor device 1 of FIG. 1. In the embodiment illustrated in FIG. 3, the first portion 151 of the first metal layer 15 extends from the first die bonding area 18 (FIG. 1) where the first semiconductor die 30 is disposed or mounted to a periphery of the through hole 12 over which the first optical device 32 is disposed or mounted. The second portion 152 of the first metal layer 15 extends from the first die bonding area 18 (FIG. 1) where the first semiconductor die 30 is disposed or mounted towards a periphery of the first substrate 10 to electrically connect to the interconnections 38. Selected I/O signals of the first semiconductor die 30 are transmitted to the first optical device 32, and others of the I/O signals of the first semiconductor die 30 are transmitted to the interconnections 38. Thus, a count of the interconnections 38 used for transmitting I/O signals can be reduced, and a count of the interconnections 38 for transmitting PWR/GND signals can be increased. Therefore, the inductance (L) can be reduced, which results in lower voltage fluctuation (ΔV) and higher quality of signal transmission.

In one or more embodiments, more than half of the interconnections 38 are used to transmit PWR/GND signals. For example, there may be 60% or more, 70% or more, 80% or more, or 90% or more of the interconnections 38 that are used to transmit PWR/GND signals.

As shown in FIG. 3, the first substrate 10 includes eight optical waveguides 16 that are disposed within the through hole 12, where four optical waveguides 16 (on the right in FIG. 3) are the first optical waveguides 16a, and four optical waveguides 16 are the second optical waveguides 16b (on the left in FIG. 3). In other embodiments, the optical waveguides 16 may be arranged in a different pattern. Further, a number of the first optical waveguides 16a may be less than or greater than a number of the second optical waveguides 16b rather than be the same.

FIG. 4 illustrates a top view of an example of the first optical device 32 of FIG. 2. As shown in FIG. 4, the light emitting region 323 is to the right and the light receiving region 324 is to the left, in the orientation shown. Four light emitting units 32a are disposed in the light emitting region 323 and are arranged in an array. Four light receiving units 32b are disposed in the light receiving region 324 and are arranged in an array. It is noted that, as shown in FIG. 2, an arrangement of the light emitting region 363, the light receiving region 364, the light emitting units 36a and the light receiving units 36b of the second optical device 36 correspond to the light receiving region 324, the light emitting region 323, the light receiving units 32b and the light emitting units 32a of the first optical device 32, respectively.

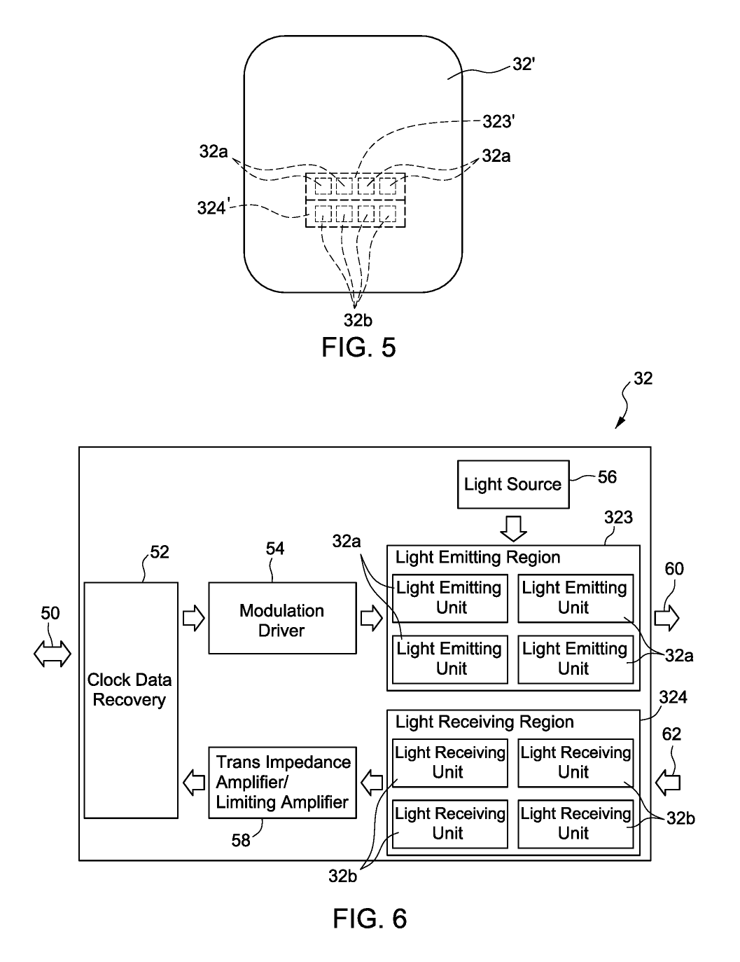

FIG. 5 illustrates a top view of an example of the first optical device 32, labeled as a first optical device 32′, according to an embodiment of the present disclosure. As shown in FIG. 5, a light emitting region 323′ includes four light emitting units 32a arranged in a row, and a light receiving region 324′ includes four light receiving units 32b arranged in a row next to the row of the light emitting units 32a.

FIG. 6 illustrates a block diagram of the first optical device 32 of FIG. 1 according to an embodiment of the present disclosure. The first optical device 32 includes clock data recovery circuitry 52, a modulation driver 54, a light emitting region 323, a light source 56, an amplifier 58 (e.g., a trans-impedance amplifier/limiting amplifier (TIA/LA)) and a light receiving region 324. Electrical signals (I/O signals) 50 received from the first semiconductor die 30 through the first portion 151 of the first metal layer 15 are received by the clock data recovery circuitry 52, and corresponding control signals are provided to the modulation driver 54 to control the light emitting units 32a in the light emitting region 323. In one or more embodiments, each of the light emitting units 32a is implemented by a photonic integrated circuit controlled by the modulation driver 54. The photonic integrated circuit is irradiated by the light source 56 (e.g., a distributed feedback laser (DFB) or vertical-cavity surface-emitting laser (VCSEL)), and is used to adjust an amount of light that passes through the photonic integrated circuit (e.g., the amount of light that the light emitting units 32a emit). Light (optical signals 60) from the light emitting units 32a is transmitted to the light receiving units 36b of the second optical device 36 through the first optical waveguides 16a (FIG. 2). Light (optical signals 62) form the light emitting units 36a of the second optical device 36 is received at the light receiving units 32b of the first optical device 32 through the second optical waveguides 16b (FIG. 2). In one or more embodiments, the light receiving units 32b are each implemented by a photo detector (PD). Signals from the light receiving units 32b are transmitted to the clock data recovery circuitry 52 through the amplifier 58. Electrical signals (I/O signals) 50 are transmitted to the first semiconductor die 30 through the first portion 151 of the first metal layer 15. It is to be understood that a block diagram of the second optical device 36 is similar to the block diagram of the first optical device 32 in FIG. 6.

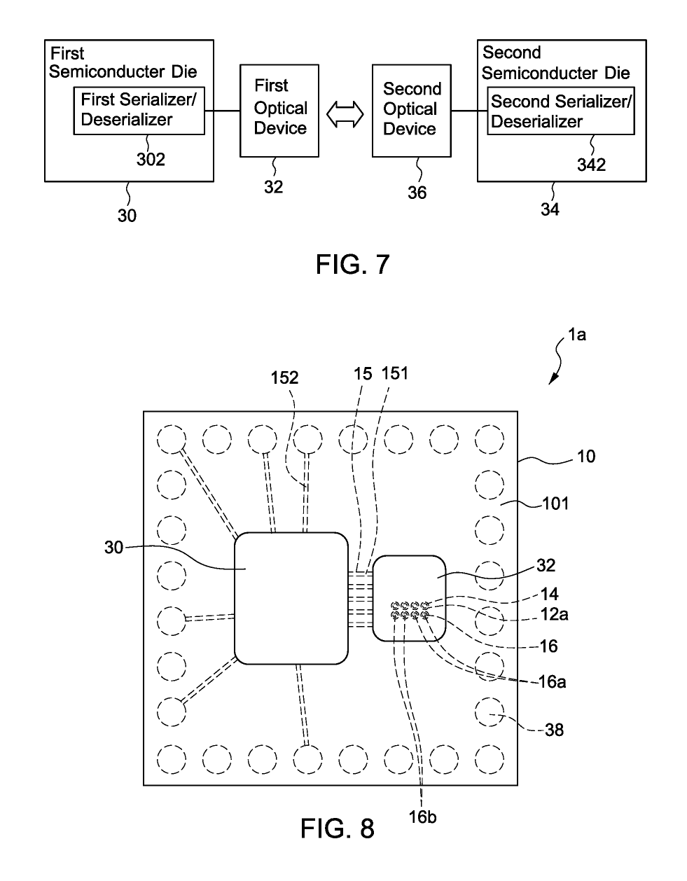

FIG. 7 illustrates a block diagram of an optical interface between the first semiconductor die 30 and the second semiconductor die 34 of FIG. 1 according to an embodiment of the present disclosure. The first semiconductor die 30 is electrically connected to the first optical device 32, and the second semiconductor die 34 is electrically connected to the second optical device 36. The first optical device 32 is optically coupled to the second optical device 36, such as by serial transmission. The first semiconductor die 30 further includes a first serializer/deserializer (SerDes) 302 electrically connected to the first optical device 32, and the second semiconductor die 34 further includes a second SerDes 342 electrically connected to the second optical device 36 to process serially-transmitted signals.

FIG. 8 illustrates a top view of an example of a semiconductor device 1a according to an embodiment of the present disclosure. The semiconductor device 1a is similar to the semiconductor device 1 as shown in FIGS. 1-7, except that multiple through holes 12a extend through the polymer material 14 in the first substrate 10, and each of the optical waveguides 16 is disposed in a respective one of the through holes 12a.

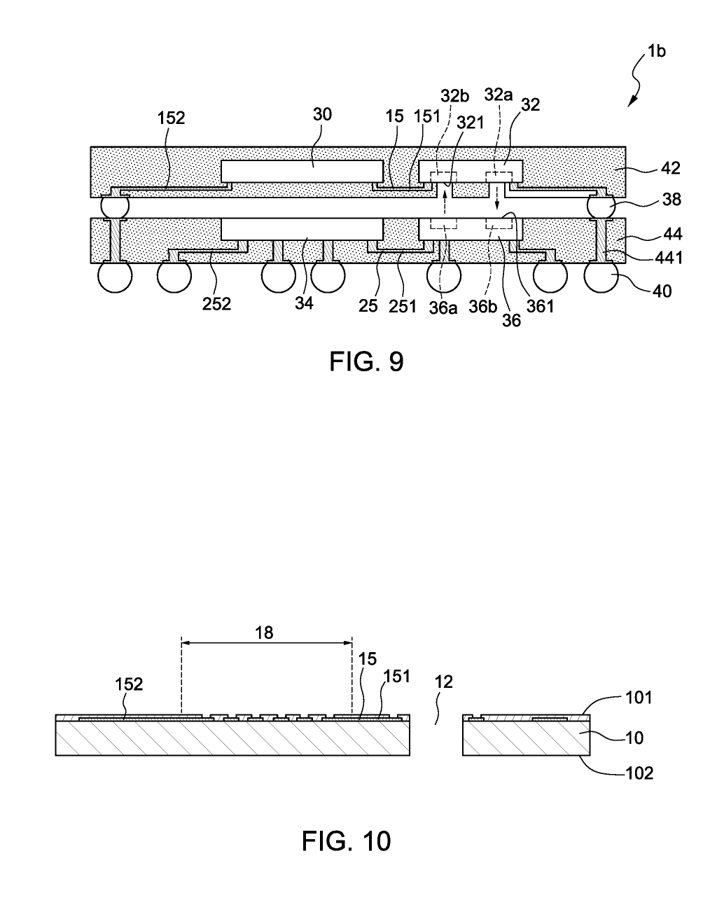

FIG. 9 is a cross-sectional illustration of an example of a semiconductor device 1b according to an embodiment of the present disclosure. Where components of the semiconductor device 1b are substantially similar to components of the semiconductor device 1 of FIG. 1, the components are numbered in the same way. The semiconductor device 1b is a semiconductor package structure and includes the first semiconductor die 30, the first optical device 32, a first encapsulant 42, the second semiconductor die 34, the second optical device 36, a second encapsulant 44 and the interconnections 38.

The first optical device 32 is electrically connected to the first semiconductor die 30, and includes the first optical surface 321 for emitting and receiving light. In one or more embodiments, the first optical device 32 includes the light emitting units 32a for emitting light (optical signals) and the light receiving units 32b for receiving light (optical signals). The first encapsulant 42 encapsulates the first semiconductor die 30 and the first optical device 32, and exposes at least a portion of the first optical surface 321. The first encapsulant 42 does not cover the light emitting units 32a and the light receiving units 32b. It is to be noted that the first encapsulant 42 may include multiple layers of encapsulant material. As shown in FIG. 9, the first encapsulant 42 embeds the first metal layer 15, and the first semiconductor die 30 is electrically connected to the first optical device 32 through the first portion 151 of the first metal layer 15.

The second optical device 36 is electrically connected to the second semiconductor die 34, and includes the second optical surface 361 for emitting and receiving light. The second optical device 36 is disposed under and aligned with the first optical device 32 so that the first optical surface 321 faces the second optical surface 361, the light emitting units 32a align with the light receiving units 36b, and the light emitting units 36a align with the light receiving units 32b. Thus, the first optical device 32 is optically coupled to the second optical device 36 directly, without an optical waveguide. The second encapsulant 44 encapsulates the second semiconductor die 34 and the second optical device 36, and exposes at least a portion of the second optical surface 361. The second encapsulant 44 does not cover the light emitting units 36a and the light receiving units 36b. It is to be noted that the second encapsulant 44 may include multiple layers of encapsulant material. As shown in FIG. 9, the second encapsulant 44 embeds the second metal layer 25, and the second semiconductor die 34 is electrically connected to the second optical device 36 through the first portion 251 of the second metal layer 25. In addition, the second encapsulant 44 may further embed conductive vias 441 for vertical (in the orientation shown) electrical connection.

The interconnections 38 are disposed between and electrically connect circuits within the first encapsulant 42 and circuits (or the conductive vias 441) within the second encapsulant 44. In one or more embodiments, more than one half of the interconnections 38 are used to transmit PWR/GND signals. Further, the first semiconductor die 30 may include the first SerDes 302 (FIG. 7) electrically connected to the first optical device 32, and the second semiconductor die 34 may include the second SerDes 342 (FIG. 7) electrically connected to the second optical device 36.

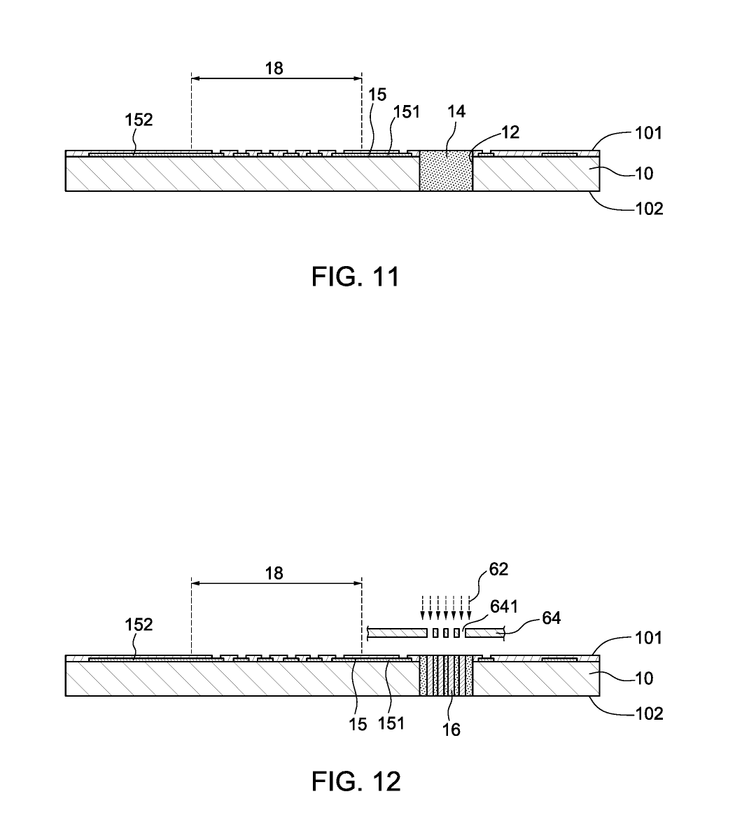

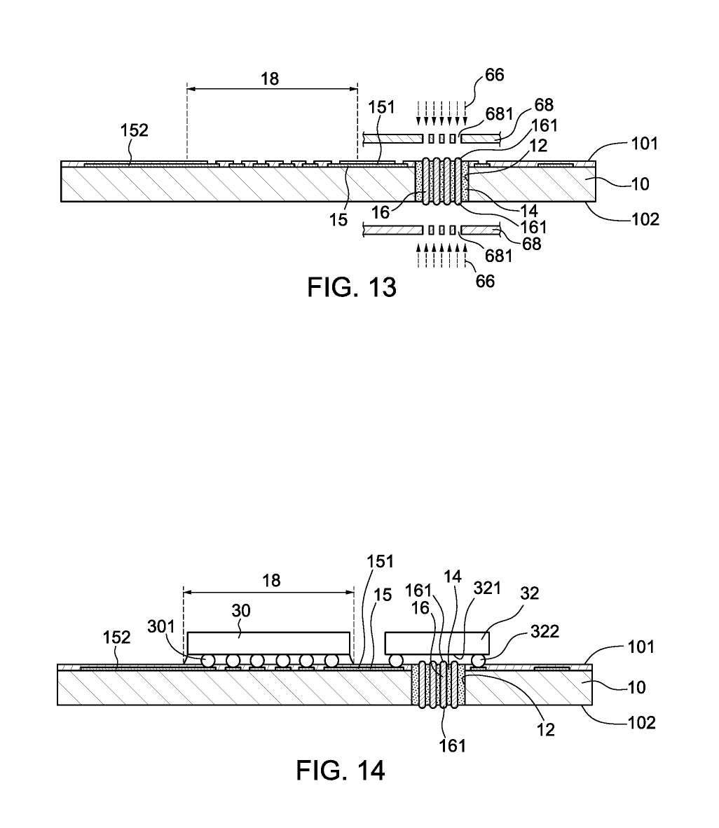

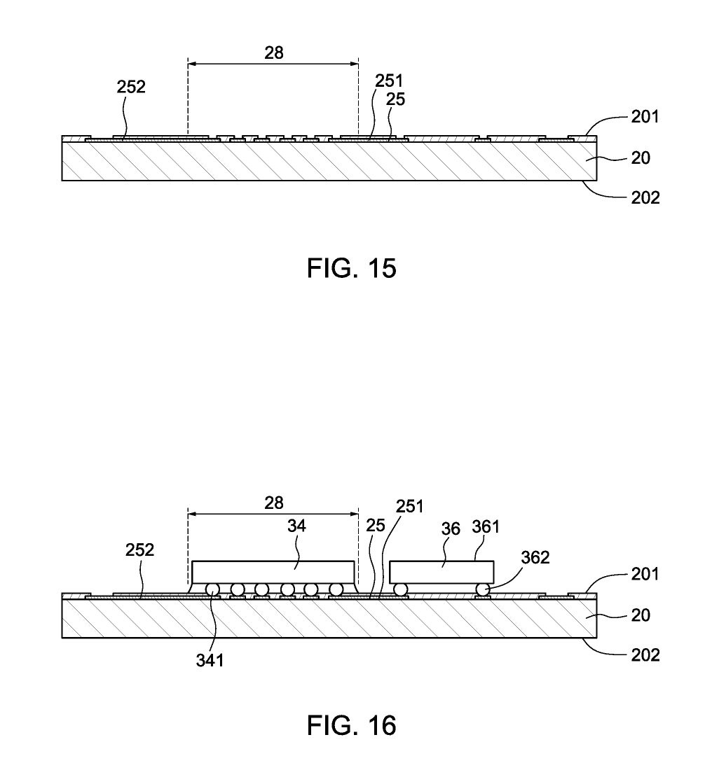

FIGS. 10-16 illustrate a manufacturing process according to an embodiment of the present disclosure. Referring to FIG. 10, a first substrate 10 is provided. In one or more embodiments, the first substrate 10 is an organic substrate so that a warpage exhibited by the first substrate 10 is low. The first substrate 10 has a first surface 101 and a second surface 102. The first substrate 10 includes a first metal layer 15 and a first die bonding area 18. The first metal layer 15 and the first die bonding area 18 are disposed adjacent to the first surface 101 of the first substrate 10. The first metal layer 15 includes a first portion 151 and a second portion 152. The first portion 151 of the first metal layer 15 extends from the first die bonding area 18 to a periphery of a predetermined position where a through hole is to be formed. The second portion 152 of the first metal layer 15 extends from the first die bonding area 18 towards a periphery of the first substrate 10. At least one through hole 12 is formed (e.g., by drilling) to extend through the first substrate 10.

Referring to FIG. 11, the through hole 12 is filled with a polymer material 14. In one or more embodiments, the polymer material 14 is a photo sensitive material, which may include PMMA, SU-8 or other suitable material. A top surface of the polymer material 14 is substantially coplanar with the first surface 101 of the first substrate 10, and a bottom surface of the polymer material 14 is substantially coplanar with the second surface 102 of the first substrate 10.

Referring to FIG. 12, a portion of the polymer material 14 is irradiated by applying a first laser 62 through a first mask 64 to form optical waveguides 16 in the polymer material 14. The first laser 62 may be a proton laser, a UV laser or an IR laser (e.g., a carbon dioxide (CO₂) laser, a neodymium (Nd)-doped laser or an ytterbium (Yb)-doped laser). The first mask 64 defines multiple through holes 641, and the exposed portions of the polymer material 14 corresponding to the through holes 641 are irradiated by the first laser 62 and are modified by the energy applied by the first laser 62 to become the optical waveguides 16. The optical waveguides 16 extend through the polymer material 14 in parallel with each other. That is, the optical waveguides 16 are formed from the polymer material 14. A molecular weight of a material of the optical waveguides 16 is less than a molecular weight of the polymer material 14, and a refractive index of the material of the optical waveguides 16 is greater than a refractive index of the polymer material 14. Therefore, substantially total reflection will occur at a boundary between the optical waveguides 16 and the polymer material 14, so that light (optical signals) can be transmitted in the optical waveguides 16. In the embodiment illustrated in FIG. 12, the optical waveguides 16 are formed by exposure and development, thus, a pitch between the optical waveguides 16 can be relatively small.

Referring to FIG. 13, micro-lenses 161 are formed at the ends of the optical waveguides 16. In one or more embodiments, the micro-lenses 161 are formed by applying a second laser 66 at two ends of each of the optical waveguides 16. As shown in FIG. 13, each end of each optical waveguide 16 is irradiated by the second laser 66 through a second mask 68 to form the micro-lenses 161. The second laser 66 may be a proton laser, a UV laser, or an IR laser (e.g., CO₂ laser, Nd-doped laser or Yb-doped laser). The first laser 62 may be different than the second laser 66, although the first laser 62 and the second laser 66 may be the same laser, a same type of laser, or similar laser (e.g., having similar specifications). A power setting of the second laser 66 may be less than a power setting of the first laser 62, such that the second laser 66 directs less energy to the optical waveguides 16 than does the first laser 62. Sizes of the micro-lenses 161 are controlled by the power setting of the second laser 66. The second mask 68 defines multiple through holes 681, and the exposed ends of the optical waveguides 16 corresponding to the through holes 681 are irradiated by the second laser 66 and are thus melted to become substantially hemispherical in shape due to surface tension of the melted optical waveguides 16, thereby forming the micro-lenses 161. There is no boundary between the optical waveguides 16 and the micro-lens 161 in the embodiment illustrated in FIG. 13.

The second mask 68 may be the first mask 64, or may be a different mask. A material and a refractive index of the micro-lenses 161 are same as the material and the refractive index of the corresponding optical waveguides 16.

Referring to FIG. 14, a first semiconductor die 30 and a first optical device 32 are attached on the first substrate 10. The first semiconductor die 30 is electrically connected to the first optical device 32. The first optical device 32 is disposed above the optical waveguides 16. In the embodiment illustrated in FIG. 14, the first optical device 32 is an optical engine that includes a first optical surface 321. The first optical surface 321 faces the optical waveguides 16, and is used for emitting and receiving light. Bumps 322 are disposed at the periphery of the through hole 12 to electrically connect the first optical device 32 to the first portion 151 of the first metal layer 15. Thus, the first semiconductor die 30 is electrically connected to the first optical device 32 through the first portion 151 of the first metal layer 15.

Referring to FIG. 15, a second substrate 20 is provided. The second substrate 20 is an organic substrate and has a first surface 201 and a second surface 202. The second substrate 20 includes a second metal layer 25 and a second die bonding area 28. The second metal layer 25 and the second die bonding area 28 are disposed adjacent to the first surface 201 of the second substrate 20. The second metal layer 25 includes a first portion 251 and a second portion 252. The first portion 251 of the second metal layer 25 extends from the second die bonding area 28 to a predefined area on which a device is to be disposed. The second portion 252 of the second metal layer 25 extends from the second die bonding area 28 towards a periphery of the second substrate 20.

Referring to FIG. 16, a second semiconductor die 34 and a second optical device 36 are attached on and electrically connected to the second substrate 20. In the embodiment illustrated in FIG. 16, the second optical device 36 is an optical engine that includes a second optical surface 361. Bumps 362 are disposed at the predefined area to electrically connect the second optical device 36 to the first portion 251 of the second metal layer 25. Thus, the second semiconductor die 34 is electrically connected to the second optical device 36 through the first portion 251 of the second metal layer 25.

Subsequently, interconnections 38 can be formed between the first substrate 10 and the second substrate 20 to electrically connect the first substrate 10 to the second substrate 20, to obtain a semiconductor device such as the semiconductor device 1 of FIGS. 1-7. In one or more embodiments, the interconnections 38 are formed on the first surface 201 of the second substrate 20; then, the second surface 102 of the first substrate 10 is attached to the interconnections 38. In other embodiments, the interconnections 38 are formed on the second surface 102 of the first substrate 10; then, the first surface 201 of the second substrate 20 is attached to the interconnections 38. After the bonding of the first substrate 10 and the second substrate 20, a position of the second optical device 36 is aligned with a position of the first optical device 32. That is, the second optical device 36 is disposed under the optical waveguides 16, and the second optical surface 361 faces the optical waveguides 16, so that the first optical device 32 is optically coupled to the second optical device 36 through the optical waveguides 16.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Two surfaces can be deemed to be coplanar or substantially coplanar if a displacement between the two surfaces is no greater than 5 μm, no greater than 2 μm, no greater than 1 μm, or no greater than 0.5 μm.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

1-7. (canceled)

8. A semiconductor device, comprising:
a first substrate comprising:
a polymer material filling at least one through hole in the first substrate; and
a plurality of optical waveguides disposed within the through hole and extending through the polymer material, wherein the optical waveguides include a first optical waveguide and a second optical waveguide, and a direction of light transmission in the first optical waveguide is different from a direction of light transmission in the second optical waveguide;
a first semiconductor die disposed on and electrically connected to the first substrate;
a first optical device electrically connected to the first substrate, the first optical device disposed above the optical waveguide;
a second substrate electrically connected to the first substrate;
a second semiconductor die disposed on and electrically connected to the second substrate; and
a second optical device electrically connected to the second substrate, wherein the second optical device is disposed under the optical waveguide.

9. The semiconductor device according to claim 8, wherein the first substrate further comprises a first metal layer, the second substrate comprises a second metal layer, the first semiconductor die is electrically connected to the first optical device through the first metal layer, the second semiconductor die is electrically connected to the second optical device through the second metal layer, and the first optical device is optically coupled to the second optical device through the optical waveguides.

10. The semiconductor device according to claim 8, further comprising a plurality of interconnections disposed between and electrically connecting the first substrate and the second substrate.

11. The semiconductor device according to claim 10, wherein more than one half of the interconnections are used to transmit power and ground signals.

12. The semiconductor device according to claim 8, wherein the first optical device includes a first optical surface for emitting and receiving light, the second optical device includes a second optical surface for emitting and receiving light, the first optical surface faces the second optical surface, and the optical waveguides are between the first optical surface and the second optical surface.

13. The semiconductor device according to claim 8, wherein the first semiconductor die comprises a first serializer/deserializer electrically connected to the first optical device, and the second semiconductor die comprises a second serializer/deserializer electrically connected to the second optical device.

14. A semiconductor package structure, comprising:
a first semiconductor die;
a first optical device electrically connected to the first semiconductor die, wherein the first optical device includes a first optical surface for emitting and receiving light; and
a first encapsulant encapsulating both the first semiconductor die and the first optical device, and exposing at least a portion of the first optical surface.

15. The semiconductor package structure according to claim 14, further comprising:
a second semiconductor die;
a second optical device electrically connected to the second semiconductor die, wherein the second optical device includes a second optical surface for emitting and receiving light, and the second optical device is disposed under the first optical device so that the first optical surface faces the second optical surface; and
a second encapsulant encapsulating the second semiconductor die and the second optical device, and exposing at least a portion of the second optical surface.

16. The semiconductor package structure according to claim 15, further comprising a first metal layer embedded in the first encapsulant, and a second metal layer embedded in second encapsulant, wherein the first semiconductor die is electrically connected to the first optical device through the first metal layer, the second semiconductor die is electrically connected to the second optical device through the second metal layer, and the first optical device is optically coupled to the second optical device.

17. The semiconductor package structure according to claim 15, further comprising a plurality of waveguides extending through the first encapsulant and positioned between the first optical surface and the second optical surface.

18. The semiconductor package structure according to claim 15, further comprising a plurality of interconnections disposed between and electrically connecting circuits within the first encapsulant and circuits within the second encapsulant.

19. The semiconductor package structure according to claim 18, wherein more than one half of the interconnections are used to transmit power and ground signals.

20. The semiconductor package structure according to claim 15, wherein the first semiconductor die comprises a first serializer/deserializer electrically connected to the first optical device, and the second semiconductor die comprises a second serializer/deserializer electrically connected to the second optical device.

21. The semiconductor device according to claim 8, wherein the second substrate is disposed under the first substrate, and the second semiconductor die is disposed between the first substrate and the second substrate.
